(19) United States
(12) Patent Application Publication
(10) Pub. No.: US 2009/0058138 A1
(43) Pub. Date: Mar. 5, 2009

(54) SLEEPER BED FOR USE IN VEHICLE

(76) Inventors: Paul G. Cech, Blair, NE (US); Jerry Miller, Blair, NE (US)

Correspondence Address: HUSCH BLACKWELL SANDERS LLP, 1620 DODGE STREET, SUITE 2100, OMAHA, NE, 68102, US

(21) Appl. No.: 12/125,969

(22) Filed: May 23, 2008

Related U.S. Application Data
(60) Provisional application No. 60/939,838, filed on May 23, 2007.

(51) Int. Cl. A47C 17/80; B60N 3/00

(52) U.S. Cl. 296/190.02; 5/694

(57) ABSTRACT

A sleeper bed for use in a vehicle comprises a frame comprising a base plate, a plurality of mounting members configured to be secured to the floor of a vehicle and coupled to the base plate, at least one longitudinal front member coupled to a plurality of the mounting members, and at least one longitudinal back member coupled to a plurality of the mounting members and a mattress configured to be supported by the base plate.

### CROSS-REFERENCE TO RELATED APPLICATION

This application claims the benefit of and priority to U.S. Provisional Patent Application No. 60/939,838, filed May 23, 2007, entitled SLEEPER BED FOR USE IN VEHICLE, which document is hereby incorporated by reference to the extent permitted by law.

### BACKGROUND OF THE INVENTION

The present invention relates generally to sleeper beds and more particularly, to sleeper beds suitable for use by an off duty driver in vehicles, such as pickup trucks, and trailers.

In order to increase highway safety, many jurisdictions around the world have adopted, or will adopt, rules limiting the number of hours a driver may drive without taking a several-hour sleep break or rest break. Moreover, many of the newer regulations actually have reduced the number of hours of continuous driving time, relative to prior standards and regulations.

The users of this system will be trucking firms that deliver cargo using one ton pickup trucks and 5th wheel trailers. These trucking firms must follow the same Dept. of Transportation as far as rest stops for drivers. To this juncture, the drivers had to pull over and use hotels. With this sleeper system, the drivers may sleep in their trucks. However, many of the pickup trucks do not have separate sleeper compartments due to the limited space or significant additional cost.

They are governed by the Dept. of Transportation trucking regulations in the same way as large over the road truck drivers. In the past, they had to sleep in hotels for their required rest stops. With this sleeper approach, they can lawfully sleep in their trucks.

### BRIEF SUMMARY OF THE INVENTION

Referring to the photographs included herewith, a longitudinally extending bed for supporting a mattress in a generally horizontal plane within a pickup truck includes at least one recessed door panel, a rigid longitudinally extending base frame, and a mattress. The sleeper bed unit is built in place of the back seat. To install the sleeper bed frame of the present invention, the back seat should be displaced.

### BRIEF DESCRIPTION OF THE DRAWINGS

FIG. 1 is a perspective view of a vehicle.

FIG. 2 is a perspective view of the interior of a vehicle.

FIG. 3 is another perspective view of the interior of a vehicle.

FIG. 4 is a perspective view of the interior of a vehicle door.

FIG. 5 is another perspective view of the interior of a vehicle.

FIG. 6 is another perspective view of the interior of a vehicle.

### DETAILED DESCRIPTION OF THE INVENTION

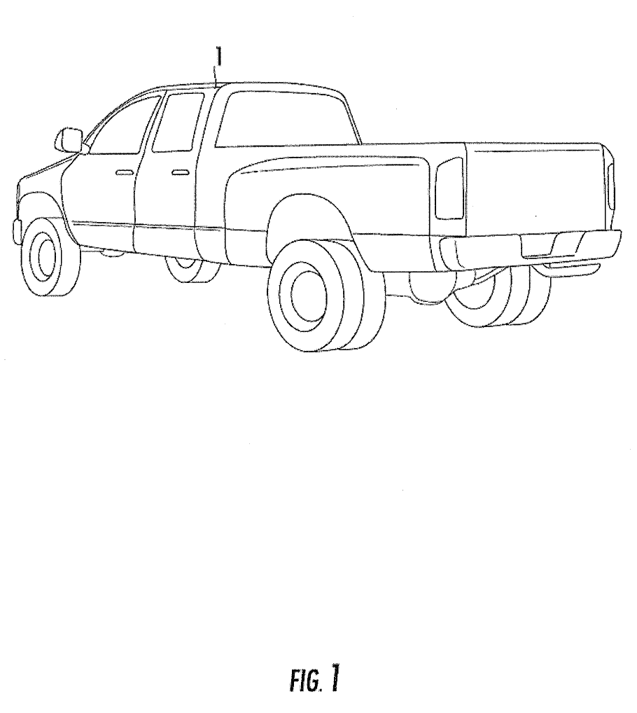

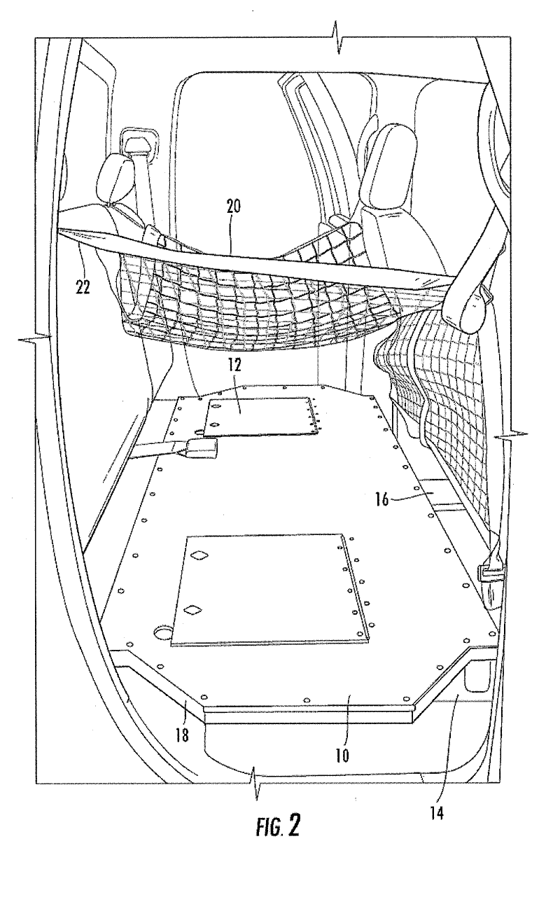

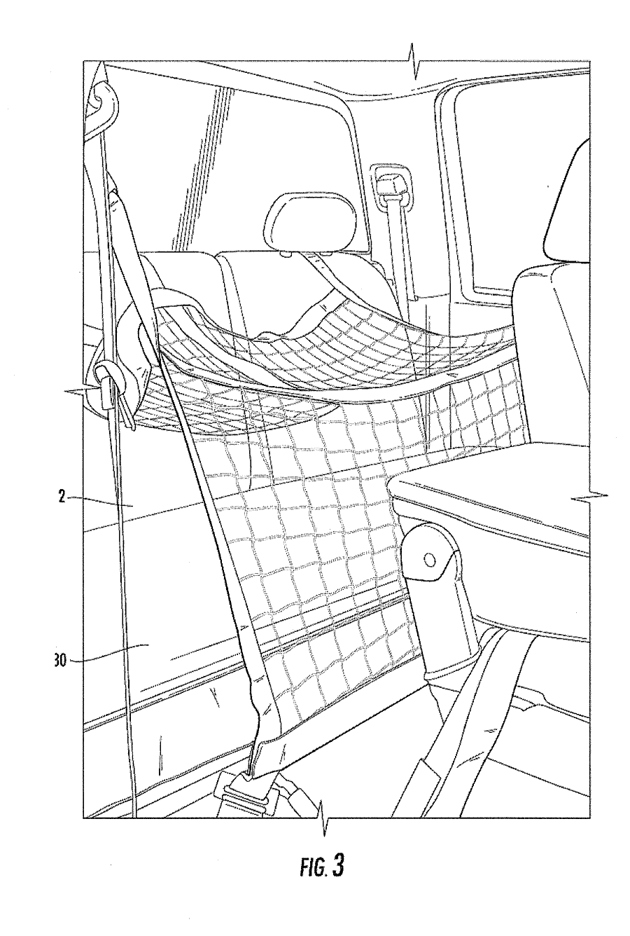

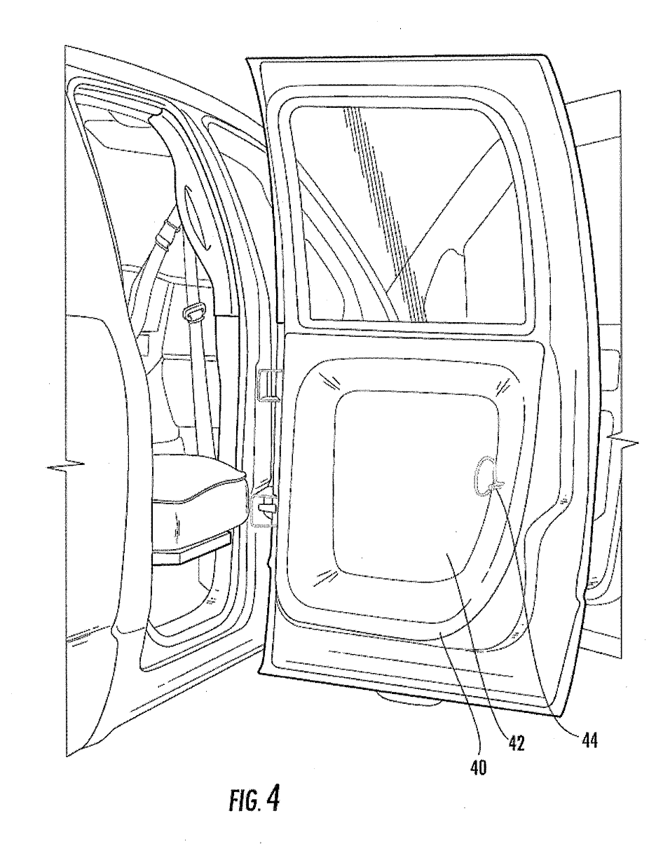

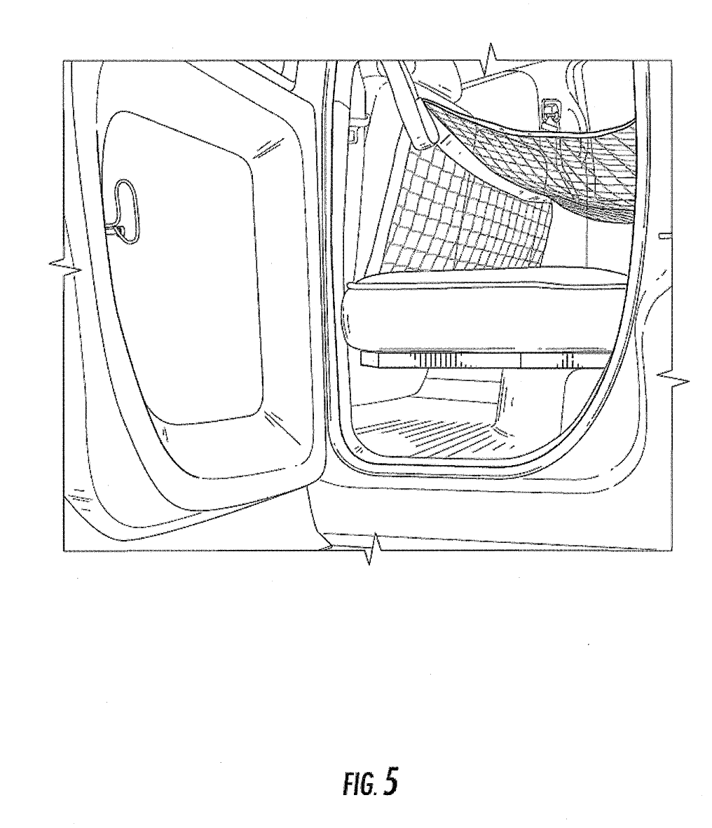

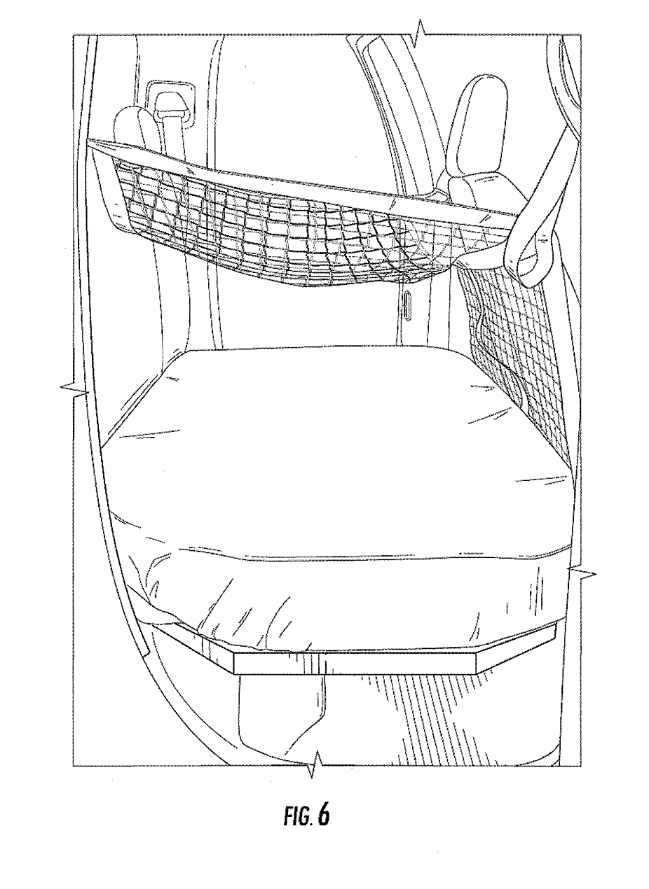

Referring to FIGS. 1-6, a sleeper bed unit 2 specifically adapted for mounting on the floor of the back seat of a vehicle comprises at least one recessed door panel 40, a base frame 10, and a mattress 30. The sleeper bed unit 2 is built in place of the back seat. The base frame 10 includes a base plate 12 and a plurality of downwardly facing mounting members 14 to support the base plate 12. The upper ends of the mounting members 14 are secured to the bottom surface of the base plate 12 and the bottom ends of the mounting members 14 are secured to the floor of the back seat area. The base frame 10 is configured to fit in the space for the back seat of the vehicle. In one embodiment, each of the corner edges 18 of the base plate 12 is defined by diagonal pieces.

The base frame 10 also includes a plurality of longitudinal front members facing the front seat. The front members are horizontally secured to the front seat by welding or other securing means. The base frame 10 also includes a plurality of longitudinal back members facing the seat back of the back seat. The back members are horizontally secured to the seat back by welding or other securing means. The base frame 10 having one side thereof arranged to fit tightly against the seat back of the back seat.

In one embodiment, the base frame 10 can include longitudinally and transversely disposed springs. The springs operate effectively to absorb and minimize vehicle vibration so that the bed is comfortably maintained. Numerous other base frames to support a mattress 30 will be readily apparent to those of ordinary skill in the art.

The size of the mattress 30 is customized to fit the space of the back seat. In one embodiment, the size of the mattress 30 is narrow, about 15″ at both sides of the mattress 30 to fit in the door area, and about 25˜30″ wide in the middle. Since typical pickup trucks have similar space of the back seat, the size of the mattress 30 does not have to be customized for each different model of the pickup truck.

The sleeper bed unit 2 comprises the recessed door panel 40. The original factory made door panel can be replaced with the recessed door panel 40. The original inside door panel has a door handle which prevents a tall driver from sleeping in a comfortable position. The recessed door panel 40 includes a recessed panel portion 42 and a door pull 44. The recessed panel portion 42 gives the sleeper more room for his or her head so that they can sleep in a comfortable position. The sleeper bed unit 2 can include two recessed door panel 40 to replace both sides of the back door panels. The door pull 44 allows the sleeper to open the door. The door pull 44 formed of wire rod would not block the sleeper's head or feet.

In one embodiment, a flexible net-like cover assembly is provided to protect the sleeper while another driver is driving the truck. The sleeper bed unit 2 comprises protective netting 20 disposed over the mattress 30. A driver can sleep in the sleeper bed while a secondary driver is driving the truck. The netting 20 is for safety of the sleeper. It reduces the risk of fatal injury to the sleeper. The netting 20 is connected to seat head rest portion with a mounting unit. The mounting unit may be constructed of any material with substantial strength to withstand the outward pressures exerted by the netting 20. For example, the mounting unit may comprise aluminum, metal, steel, plastics, composite materials such as carbon fiber, strong woods and laminates of woods, or a combination thereof. The protective netting 20 includes a plurality of straps 22 attached to the border of the protective netting 20. Each of the straps 22 engages with the mounting unit. In another embodiment, the protective netting 20 can be held in place by a portion of the head rest.

For installation, the back seat of a vehicle is removed and the base frame 10 is introduced to the back seat in a compact state. After introduction of the base frame 10 to the interior space for the back seat of the vehicle, the base frame 10 is affixed to the surface of the vehicle, such as by welding.

Although the foregoing has been described with reference to exemplary embodiments, workers skilled in the art will recognize that changes may be made in form and detail without departing from the spirit and scope thereof. For example, although different example embodiments may have been described as including one or more features providing one or more benefits, it is contemplated that the described features may be interchanged with one another or alternatively be combined with one another in the described example embodiments or in other alternative embodiments. The present subject matter described with reference to the example embodiments and set forth in the following claims is manifestly intended to be as broad as possible. For example, unless specifically otherwise noted, the claims reciting a single particular element also encompass a plurality of such particular elements.

Many other changes and modifications may be made to the present invention without departing from the spirit thereof. The scope of these and other changes will become apparent from the appended claims. The steps of the methods described herein may be varied, and carried out in different sequences.

What is claimed is:

1. A sleeper bed for use in a vehicle, the sleeper bed comprising:
a frame comprising a base plate, a plurality of mounting members configured to be secured to the floor of a vehicle and coupled to the base plate, at least one longitudinal front member coupled to a plurality of the mounting members, and at least one longitudinal back member coupled to a plurality of the mounting members; and
a mattress configured to be supported by the base plate.

2. The sleeper bed of claim 1, wherein at least one of the longitudinal front members is directly coupled to the front seat.

3. The sleeper bed of claim 1, wherein at least one of the longitudinal back members is directly coupled to the back seat.

4. A vehicle comprising:
a front seat;
a door having a recessed panel;
a sleeper bed comprising a frame having a base plate, a plurality of mounting members configured to be secured to the floor of a vehicle and coupled to the base plate, at least one longitudinal front member coupled to a plurality of the mounting members, and at least one longitudinal back member coupled to a plurality of the mounting members;
wherein at least one of the longitudinal front members is directly coupled to the front seat, and at least one of the longitudinal back members is directly coupled to the back seat.
